(19) United States
(12) Patent Application Publication
(10) Pub. No.: US 2002/0132742 A1
(43) Pub. Date: Sep. 19, 2002

(54) Composition for cleaning fruits, vegetables and food contact surfaces

(76) Inventor: Peter Y. Mizuki, Racine, WI (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/004,628

(22) Filed: Dec. 4, 2001

Related U.S. Application Data
(63) Continuation-in-part of application No. 09/731,107, filed on Dec. 6, 2000, now abandoned.

(51) Int. Cl. A01K 43/00; C11D 17/00

(52) U.S. Cl. 510/111; 510/477; 510/424

(57) ABSTRACT

A composition for cleaning fruits, vegetables and hard, foot contact surfaces. The composition contains an edible organic acid, an anionic surfactant, a nonionic surfactant having a hydrophilic-lipophilic balance in the range of between 12 to 16. In one embodiment, the nonionic surfactant is a nonethoxylated sorbitan derivative and an ethoxylated sorbitan derivative. In a preferred embodiment, the composition is stabilized with a food grade alcohol.

### CROSS REFERENCE TO RELATED APPLICATIONS

This is a Continuation-In-Part of patent application Ser. No. 09/731,107 filed Dec. 6, 2000.

### STATEMENT REGARDING FEDERALLY SPONSORED RESEARCH OR DEVELOPMENT

NONE

### BACKGROUND OF THE INVENTION

1. Technical Field

This invention relates to a composition for cleaning fruits, vegetables and hard, food contact surfaces. More particularly, this invention relates to a composition of the foregoing type which is effective in hard water, effective against a broad spectrum of bacteria and effective in wax removal from fruits.

2. Background Art

There are available several compositions for cleaning fruits and vegetables. For example, U.S. Pat. No. 4,140,694 discloses a composition for cleaning the surface of food including those of plant origin with a mixture including citric acid, lauryl sulfate and Tween 80 surfactant. In U.S. Pat. No. 5,320,772, there is disclosed a fruit and vegetable cleaning composition which includes sodium lauryl sulfate and nonionic surfactants, such as Tween surfactants. Polyoxyethylene sorbitan fatty acid monoesters are described in U.S. Pat. No. 4,002,579 for cleaning Chinese cabbages. U.S. Pat. No. 5,549,758 teaches the use of clear solutions for cleaning produce with a nonionic surfactant having a hydrophilic-lipophilic balance (HLB) greater than 10. Concerning acid compositions, low HLB are taught.

In order to preserve some fruits and vegetables, they are coated with an oily or waxy coating. In many instances, it is desirable to remove this coating material before ingestion. The prior art does not provide a cleaning composition for fruits and vegetables which is active in hard water, is effective against a broad spectrum of bacteria and can also remove wax.

The objects of the invention therefore are:

a. Providing an improved composition for cleaning fruits, vegetables and hard, food contact surfaces.

b. Providing a cleaning composition of the foregoing type which is effective in hard water.

c. Providing a cleaning composition of the foregoing type which is effective against a broad spectrum of bacteria.

d. Providing a cleaning composition of the foregoing type which can remove wax from fruit in an efficient manner.

These and still other objects and advantages of the invention will be apparent from the description which follows. In the detailed description below preferred embodiments of the invention will be described in reference to the full scope of the invention. Rather, the invention may be employed in other embodiments.

### SUMMARY OF THE INVENTION

The foregoing objects are accomplished and the shortcomings of the prior art are overcome by the edible fruit, vegetable and hard, food contact surface cleaning composition of this invention which includes in one embodiment an edible organic acid, an anionic surfactant, a nonethoxylated sorbitan derivative, an ethoxylated sorbitan derivative, and water.

In a preferred embodiment, a food grade alcohol such as ethanol is incorporated as a stabilizing agent.

In another embodiment, the sorbitan derivatives are derived from a C₁₂-C₁₈ aliphatic acid.

In yet another embodiment, there is provided an edible fruit, vegetable and hard, food contact surface cleaning composition which includes an edible organic acid, an anionic surfactant, a nonionic surfactant having a HLB in the range of 12 to 16, a food grade alcohol and water.

In a preferred embodiment, the edible organic acid is lactic acid, the anionic surfactant is sodium lauryl sulfate, and the sorbitan derivatives are sorbitan monooleates.

In one aspect, the composition includes about 10%/wt. to about 45%/wt. of an edible organic acid, about 5%/wt. to about 30%/wt. of an anionic surfactant, about 6%/wt. to about 15%/wt. of a nonethoxylated sorbitan derivative and an ethoxylated sorbitan derivative, and 10%/wt. to about 79%/wt. of water.

In another aspect, the composition includes about 5%/wt. to about 40%/wt. of an edible organic acid, about 5%/wt. to about 15%/wt. of an anionic surfactant, about 6%/wt. to about 15%/wt. of a nonethoxylated sorbitan derivative and an ethoxylated sorbitan derivative, about 1%/wt. to about 7%/wt. of a food grade alcohol, and 23%/wt. to about 83%/wt. of water.

In a preferred aspect, the composition includes about 16%/wt. of an edible organic acid, about 9.6%/wt. of an anionic surfactant, about 1%/wt. of a nonethoxylated sorbitan derivative, about 12%/wt. of an ethoxylated sorbitan derivative and about 61.4%/wt. water.

In another preferred aspect, the composition includes about 16.9%/wt. of an edible organic acid, about 9.6%/wt. of an anionic surfactant, about 3%/wt. of a nonethoxylated sorbitan derivative, about 12%/wt. of an ethoxylated sorbitan derivative, about 3%/wt. of ethanol and about 56.4%/wt. of water.

In yet another aspect, the nonethoxylated sorbitan derivative and the ethoxylated sorbitan derivative are present in a ratio of about 1:4 to 1:12, respectively.

### DESCRIPTION OF THE PREFERRED EMBODIMENTS

The following procedures are employed in preparing the compositions of Examples 1 to 51 depending upon whether a liquid or powder form of sodium lauryl sulfate was used.

In the following Examples, the amounts of materials are expressed in terms of weight %.

### Procedure A

1. CHARGE THE DEIONIZED WATER TO A CLEAN DRY MIXING VESSEL. USE COLD WATER.

2. WHILE STIRRING, SIFT IN THE SODIUM LAURYL SULFATE, AVOIDING THE FORMATION OF CLUMPS. STIR UNTIL TOTALLY DISSOLVED.

3. CONTINUE STIRRING, ADD THE CITRIC ACID, FCC USP, ANHYDROUS. STIR UNTIL TOTALLY DISSOLVED.

4. IN A SEPARATE VESSEL, ADD THE POLYOXYETHYLENE (20) SORBITAN MONOOLEATE, START STIRRING THEN ADD THE SORBITAN MONOOLEATE. STIR TO UNIFORMITY. WHILE STIRRING, ADD THE MIXTURE FROM STEP 4. STIR TO UNIFORMITY.

### Procedure B

1. CHARGE THE DEIONIZED WATER TO A CLEAN DRY MIXING VESSEL. USE COLD WATER.

2. WHILE STIRRING, ADD THE 30% LIQUID SODIUM LAURYL. STIR UNTIL TOTALLY DISSOLVED.

3. CONTINUE STIRRING, ADD THE CITRIC ACID, FCC USP, ANHYDROUS. STIR UNTIL TOTALLY DISSOLVED.

4. IN A SEPARATE VESSEL, ADD THE POLYOXYETHYLENE (20) SORBITAN MONOOLEATE. START STIRRING, THEN ADD THE SORBITAN MONOOLEATE. STIR TO UNIFORMITY.

5. WHILE STIRRING, ADD THE MIXTURE FROM STEP 4. STIR TO UNIFORMITY.

One of the acids for use in the composition of this invention is citric acid and the preferred anionic surfactant is sodium lauryl sulfate. The preferred sorbitan ester-ethoxylated sorbitan ester mixture is any combination of sorbitan monooleate and ethoxylated sorbitan monooleate that results in a net HLB between 12.2 to 14.2, most preferably 14.2. This is seen in Examples 1-7. It has been found that an HLB of 14.17 results in a more stable product.

The calculation of a net HLB is well known to those skilled in the art, as set forth in Surfactants and Interfacial Phenomena, Second Edition, John Wiley & Sons (1989), pages 326-329, which teachings are incorporated herein by reference.

| | | Ex. 1 | Ex. 2 | Ex. 3 | Ex. 4 | Ex. 5 | Ex. 6 | Ex. 7 |
|---|---|---|---|---|---|---|---|---|
| | Citric Acid | 10.00 | 10.00 | 10.00 | 10.00 | 10.00 | 10.00 | 16.0 |
| | Sodium Lauryl Sulfate | 15.00 | 15.00 | 15.00 | 15.00 | 15.00 | 15.00 | 9.6 |
| Span 80 | Sorbitan Monooleate | 3.33 | 2.50 | 2.00 | 1.67 | 1.25 | 1.00 | 1.0 |
| Tween 80 | Polyoxyethylene (20) | 6.67 | 7.50 | 8.00 | 8.33 | 8.75 | 9.00 | 12 |
| | Sorbitan Monooleate | | | | | | | |
| | Deionized Water | qs to | qs to | qs to | qs to | qs to | qs to | qs to |
| | | 100 | 100 | 100 | 100 | 100 | 100 | 100 |
| | Net HLB | 11.47 | 12.33 | 12.86 | 13.21 | 13.66 | 13.93 | 14.17 |
| | 1:100 dilution, 24 hours* | ppt | clear | clear | clear | clear | clear | clear** |
| | 1:100 dilution, 48 hours* | ppt | clear | clear | clear | clear | clear | clear** |

*300 ppm hard water
**Indicate a 1:150 dilution for both 24 and 48 hours.

It should be pointed out that sorbitan ester-ethoxylated sorbitan ester combinations, when diluted without the acid-anionic surfactant present, themselves form cloudy solutions.

Optionally, the sorbitan monooleate and the ethoxylated sorbitan monooleate may be substituted in whole or in part with other sorbitan derivatives of monolaurate, monopalmitate, monostearate, trioleate. Preferred are the liquid forms (sorbitan monooleate, sorbitan monolaurate and sorbitan trioleate). The solid forms can be used if liquefied by heating all the ingredients, but limits the dilution phase to while the concentrate is still warm (the concentrate will solidify as it cools to room temperature). The solutions, however, exhibit water-clear stability when diluted in 600 ppm hardness water. Use of other sorbitan derivatives increases the effective net HLB range to between 12.2 and 15.9, again with the most preferable net HLB being 13.3. This is seen in Examples 8-20.

| | | Ex. 8 | Ex. 9 | Ex. 10 | Ex. 11 | Ex. 12 | Ex. 13 | Ex. 14 |
|---|---|---|---|---|---|---|---|---|
| | Citric Acid | 10.0000 | 10.0000 | 10.0000 | 10.0000 | 10.0000 | 10.0000 | 10.0000 |
| | Sodium Lauryl Sulfate | 15.0000 | 15.0000 | 15.0000 | 15.0000 | 15.0000 | 15.0000 | 15.0000 |
| Span 20 | Sorbitan Monolaurate | 4.1980 | 0.0000 | 3.2860 | 2.5400 | 4.1980 | — | — |
| Span 80 | Sorbitan Monooleate | | | | | | 2.7420 | 2.0350 |
| Span 85 | Sorbitan Trioleate | | | | | | | |
| Tween 20 | Polyoxyethylene (20) | 5.8020 | — | — | — | — | 7.2580 | — |
| | Sorbitan Monolaurate | | | | | | | |
| Tween 21 | Polyoxyethylene (4) | — | 10.0000 | — | — | — | — | — |
| | Sorbitan Monolaurate | | | | | | | |
| Tween 40 | Polyoxyethylene (20) | — | — | 6.7140 | — | — | — | 7.9650 |
| | Sorbitan Monopalmitate | | | | | | | |
| Tween 60 | Polyoxyethylene (20) | — | — | — | 7.4600 | — | — | — |
| | Sorbitan Monostearate | | | | | | | |
| Tween 80 | Polyoxyethylene (20) | — | — | — | — | 5.8020 | — | — |
| | Sorbitan Monooleate | | | | | | | |
| | Deionized Water | qs to | qs to | qs to | qs to | qs to | qs to | qs to |
| | | 100 | 100 | 100 | 100 | 100 | 100 | 100 |
| | Net HLB Span + Tween | 13.30 | 13.30 | 13.30 | 13.30 | 13.30 | 13.30 | 13.30 |
| | 1:100 dilution, 24 hours* | clear | clear | clear | clear | clear | clear | clear |
| | 1:100 dilution, 48 hours* | clear | clear | clear | clear | clear | clear | clear |

| | | Ex. 15 | Ex. 16 | Ex. 17 | Ex. 18 | Ex. 19 | Ex. 20 |
|---|---|---|---|---|---|---|---|
| | Citric Acid | 10.0000 | 10.0000 | 10.0000 | 10.0000 | 10.0000 | 10.0000 |
| | Sodium Lauryl Sulfate | 15.0000 | 15.0000 | 15.0000 | 15.0000 | 15.0000 | 15.0000 |
| Span 20 | Sorbitan Monolaurate | — | — | — | — | — | — |
| Span 80 | Sorbitan Monooleate | 1.5090 | 1.5890 | — | — | — | — |
| Span 85 | Sorbitan Trioleate | | | 2.2820 | 1.6670 | 1.2210 | 1.2650 |
| Tween 20 | Polyoxyethylene (20) | — | — | 7.7180 | — | — | — |
| | Sorbitan Monolaurate | | | | | | |
| Tween 21 | Polyoxyethylene (4) | — | — | — | — | — | — |
| | Sorbitan Monolaurate | | | | | | |
| Tween 40 | Polyoxyethylene (20) | — | — | — | 8.3330 | — | — |
| | Sorbitan Monopalmitate | | | | | | |
| Tween 60 | Polyoxyethylene (20) | 8.4910 | — | — | — | 7.7790 | — |
| | Sorbitan Monostearate | | | | | | |
| Tween 80 | Polyoxyethylene (20) | — | 8.4110 | — | — | — | 8.7350 |
| | Sorbitan Monooleate | | | | | | |
| | Deionized Water | qs to | qs to | qs to | qs to | qs to | qs to |
| | | 100 | 100 | 100 | 100 | 100 | 100 |
| | Net HLB Span + Tween | 13.30 | 13.30 | 13.30 | 13.30 | 13.30 | 13.30 |
| | 1:100 dilution, 24 hours* | clear | clear | clear | clear | clear | clear |
| | 1:100 dilution, 48 hours* | clear | clear | clear | clear | clear | clear |

*600 ppm hard water

Alternatively, the sorbitan ester-ethoxylated sorbitan ester can be substituted with other toxicologically acceptable nonionic surfactant(s) (e.g., derived from edible oils) if the net HLB is in the range between 12.2 and 15.9, with the most preferable net HLB being 13.3.

Optionally, citric acid may be substituted in whole or in part with food grade acids such as benzoic, lactic and acetic acids. This is depicted in the following Example 21.

| | | Ex. 21 |
|---|---|---|
| | Lactic Acid | 10.56 |
| | Sodium Lauryl Sulfate | 15.00 |
| Span 80 | Sorbitan Monooleate | 2.00 |
| Tween 80 | Polyoxyethylene (20) | 8.00 |
| | Sorbitan Monooleate | |
| | Deionized Water | qs to 100 |
| | 1:100 dilution, 24 hours* | clear |
| | 1:100 dilution, 48 hours* | clear |

*300 ppm hard water

From a stability standpoint, it has been found that a 16.9% lactic acid composition is preferred with 9.6% sodium lauryl sulfate and 13% of the sorbitan esters. However, the composition is a 1:150 dilution for 24 hours in 300 ppm hard water.

As shown in Examples 22 and 23, sodium lauryl sulfate may be substituted optionally in whole or in part by other toxicologically acceptable anionic surfactants such as dodecyl benzene sulfonic acid.

| | | Ex. 22 | Ex. 23 |
|---|---|---|---|
| | Citric Acid | 10.00 | 15.00 |
| | Sodium Lauryl Sulfate | 15.00 | - |
| | Dodecyl Benzene | - | 15.00 |
| | Sulfonic Acid | | |
| Span 80 | Sorbitan Monooleate | 1.67 | 1.67 |
| Tween 80 | Polyoxyethylene (20) | 8.33 | 8.33 |
| | Sorbitan Monooleate | | |
| | Deionized Water | qs to 100 | qs to 100 |
| | 1:100 dilution, 24 hour* | clear | clear |
| | 1:100 dilution, 48 hour* | clear | clear |

*300 ppm hard water

For use, and as seen in Examples 1-46, the concentrate is diluted with potable water at the rate of 1:100 concentrate: water. To illustrate the enhanced stability of the invention, the concentrate is diluted with water containing 300 or 600 ppm hardness ions (Ca:Mg ratio 2:1). The water is prepared according to the method in ASTM D 3050-72T. This is shown in Example 24.

### EX. 24

### Hard Water Stock Solution

### Materials

### Calcium Chloride Dihydrate

### Magnesium Chloride Hexahydrate

### 1 liter Volumetric Flask

### Balance+/−0.0005 Accuracy

### Deionized Water

### Prepare a Hard Water Stock Solution by Dissolving 2.940+/−0.002 Grams of Calcium Chloride Dihydrate and 2.033+/−0.002 Grams of Magnesium Chloride Hexahydrate

In approximately 300 ml of deionized water in the 1 liter volumetric flask. Dilute to 1 liter with additional deionized water.

This solution contains 3,000 ppm hardness (expressed as calcium carbonate) with a Calcium:Magnesium molar ratio of 2:1

Source: ASTM Designation D 3050-72T

It is noted that the combination without the sorbitan ester-ethoxylated sorbian ester combination, the diluted solution becomes cloudy and the anionic-hard water precipitate forms. There is also a minimum quantity of the sorbitan ester-ethoxylated sorbitan ester combination required to effectively inhibit the precipitate formation for periods of time greater than 48 hours. As seen in Examples 25-35 for the monooleate combination the minimum is >6%.

| | Ex. 25 | Ex. 26 | Ex. 27 | Ex. 28 | Ex. 29 | Ex. 30 |
|---|---|---|---|---|---|---|
| Citric Acid | 10.000 | 10.000 | 10.000 | 10.000 | 10.000 | 10.000 |
| Sodium Lauryl | 15.000 | 15.000 | 15.000 | 15.000 | 15.000 | 15.000 |
| Sulfate | | | | | | |
| Sorbitan | 0.000 | 0.159 | 0.318 | 0.477 | 0.636 | 0.795 |
| Monooleate | | | | | | |
| Polyoxy- | 0.000 | 0.841 | 1.682 | 2.523 | 3.364 | 4.205 |
| ethylene | | | | | | |
| (20) Sorbitan | | | | | | |
| Monooleate | | | | | | |
| Deionized | 75.000 | 74.000 | 73.000 | 72.000 | 71.000 | 70.000 |
| Water | | | | | | |
| 1:100 dilution, | ppt | ppt | ppt | ppt | ppt | ppt |
| 24 hours* | | | | | | |
| 1:100 dilution, | — | — | — | — | — | — |
| 48 hours* | | | | | | |

*600 ppm hard water

| | Ex. 31 | Ex. 32 | Ex. 33 | Ex. 34 | Ex. 35 |
|---|---|---|---|---|---|
| Citric Acid | 10.000 | 10.000 | 10.000 | 10.000 | 10.000 |
| Sodium Lauryl | 15.000 | 15.000 | 15.000 | 15.000 | 15.000 |
| Sulfate | | | | | |
| Sorbitan | 0.954 | 1.113 | 1.272 | 1.431 | 1.590 |
| Monooleate | | | | | |
| Polyoxy- | 5.046 | 5.887 | 6.728 | 7.569 | 8.410 |
| ethylene | | | | | |
| (20) Sorbitan | | | | | |
| Monooleate | | | | | |
| Deionized | 69.000 | 68.000 | 67.000 | 66.000 | 65.000 |
| Water | | | | | |
| 1:100 dilution, | clear | clear | clear | clear | clear |
| 24 hours* | | | | | |
| 1:100 dilution, | clear | clear | clear | clear | clear |
| 48 hours* | | | | | |

*600 ppm hard water

The quantity of citric acid and sodium lauryl sulfate is limited by its capability to dissolve to form flowable solutions. Otherwise a gel or paste state is formed which limits the ability to be easily dissolved. The level of citric acid can range up to 45% of the formula concentrate. The level of sodium lauryl sulfate can range up to 30% of the formula concentrate. This is illustrated in the following Examples 36-50.

| | | Ex. 36 | Ex. 37 | Ex. 38 | Ex. 39 | Ex. 40 | Ex. 41 | Ex. 42 | Ex. 43 |
|---|---|---|---|---|---|---|---|---|---|
| | Citric Acid | 10.00 | 15.00 | 20.00 | 25.00 | 30.00 | 35.00 | 40.00 | 45.00 |
| | Sodium Lauryl Sulfate | 15.00 | 15.00 | 15.00 | 15.00 | 15.00 | 15.00 | 15.00 | 13.50 |
| Span 80 | Sorbitan Monooleate | 2.00 | 2.00 | 2.00 | 2.00 | 2.00 | 2.00 | 2.00 | 2.00 |
| Tween 80 | Polyoxyethylene (20) | 8.00 | 8.00 | 8.00 | 8.00 | 8.00 | 8.00 | 8.00 | 8.00 |
| | Sorbitan Monooleate | | | | | | | | |
| | Deionized Water | qs to | qs to | qs to | qs to | qs to | qs to | qs to | qs to |
| | | 100 | 100 | 100 | 100 | 100 | 100 | 100 | 100 |
| | 1:100 dilution, | clear | clear | clear | clear | clear | clear | clear | clear |
| | 24 hours* | | | | | | | | |
| | 1:100 dilution, | clear | clear | clear | clear | clear | clear | clear | clear |
| | 48 hours* | | | | | | | | |

*300 ppm hard water

| | | Ex. 44 | Ex. 45 | Ex. 46 | Ex. 47 |
|---|---|---|---|---|---|
| | Citric Acid | 10.00 | 10.00 | 10.00 | 10.00 |
| | Sodium Lauryl | 15.00 | 18.00 | 21.00 | 24.00 |
| | Sulfate | | | | |
| Span | Sorbitan | 1.67 | 1.67 | 1.67 | 1.67 |
| 80 | Monooleate | | | | |
| Tween | Polyoxy- | 8.33 | 8.33 | 8.33 | 8.33 |
| 80 | ethylene | | | | |
| | (20) Sorbitan | | | | |
| | Monooleate | | | | |
| | Deionized | qs to 100 | qs to 100 | qs to 100 | qs to 100 |
| | Water | | | | |
| | 1:100 dilution, | clear | clear | clear | clear |
| | 24 hours* | | | | |
| | 1:100 dilution, | clear | clear | clear | clear |
| | 48 hours* | | | | |

*300 ppm hard water

| | Ex. 48 | Ex. 49 | Ex. 50 |
|---|---|---|---|
| Citric Acid | 20.000 | 15.000 | 10.000 |
| Sodium Lauryl Sulfate | 30.000 | 22.500 | 15.000 |
| Sorbitan Monooleate | 2.226 | 1.670 | 1.113 |
| Polyoxyethylene (20) | 11.774 | 8.830 | 5.887 |
| Sorbitan Monooleate | | | |
| Deionized Water | 36.000 | 52.000 | 68.000 |
| form | gel | viscous | liquid |
| | | liquid | |

The capacity to vary the level of ingredients in this invention allows various dilution ratios to be used and thus yield different levels of physical characteristics. For example, reducing the level of sodium lauryl sulfate with a corresponding reduction in the sorbitan ester-ethoxylated sorbitan ester mixture still produces a stable concentrate. The dilution has still good wetting properties and is efficacious against gram negative and gram positive bacteria but is less foamy. Less foam is desirable in applications where the article to be cleaned needs to be rinsed with potable water. Alternatively, the level of citric acid can be increased in the concentrate. This allows for use of a higher dilution ratio to produce a less foamy solution that still has good wetting properties and is efficacious against gram negative and gram positive bacteria. This is depicted in the following Examples 51 and 52.

| | | Ex. 51 | | Ex. 52 | |
|---|---|---|---|---|---|
| | Citric Acid | 10.00 | | 25.00 | |
| | Sodium Lauryl | 15.00 | | 15.00 | |
| | Sulfate | | | | |
| Span | Sorbitan | 2.00 | | 2.00 | |
| 80 | Monooleate | | | | |
| Tween | Polyoxyethylene | 8.00 | | 8.00 | |
| 80 | (20) Sorbitan | | | | |
| | Monooleate | | | | |
| | Deionized Water | qs to 100 | | qs to 100 | |
| | 1:100 dilution* | Staph aureus | +0/10 | — | — |
| | | Salmonella | +0/10 | — | — |
| | | E. coli | +0/10 | — | — |
| | 1:200 dilution* | — | — | Staph aureus | +0/10 |
| | | — | — | Salmonella | +0/10 |
| | | — | — | E. Coli | +0/10 |

*Deionized Water

It has been found that the sorbitan esters have limited stability in the presence of organic acids of the previous compositions. It has been found that addition of small quantities of an alcohol, preferably ethanol, greatly enhances the stability of the sorbitan esters in the compositions. Of the alcohols, ethanol is preferred because it is an edible ingredient.

The preferred acid for the stabilized composition of this invention is lactic acid (FCC grade), and the preferred anionic surfactant is sodium lauryl sulfate (USP grade). The preferred sorbitan derivative is a kosher sorbitan monooleate and the preferred ethoxylated sorbitan derivative is a kosher ethoxylated (20 mole EO) sorbitan monooleate. The kosher sorbitan derivatives are preferred for the source of the aliphatic acid. The preferred alcohol is ethanol, USP grade.

The following procedure is employed in preparing the stabilized compositions:

### Procedure C

1. Charge the deionized water to a clean dry mixing vessel.

2. While stirring, add the lactic acid. Stir until homogeneous.

3. In a separate vessel, add the polyoxyethylene (20) sorbitan monooleate, sorbitan monooleate, and ethanol. Stir until homogeneous.

4. While stirring, add the mixture from step 3. Stir until homogeneous.

5. While stirring, add the sodium lauryl sulfate. Stir until homogeneous.

Depending on the compositional level of the ingredients, the composition is initially a clear, homogeneous liquid or a hazy liquid within a few hours after completion. Within 7 days after completion, the hazy composition becomes a transparent homogenous liquid of enhanced stability. This is shown in Examples 53 and 54.

| | Ex. 53 | Ex. 54 |
|---|---|---|
| Lactic Acid | 16.9 | 16.9 |
| Sodium Lauryl Sulfate | 9.6 | 9.6 |
| Sorbitan Monooleate | 3.0 | 3.0 |
| Polyoxyethylene (20) Sorbitan Monooleate | 12.0 | 12.0 |
| Ethanol | - | 3.0 |
| Deionized water | q.s. to 100 | q.s. to 100 |
| Appearance after 6 months at room | Phase | Clean & |
| temperature | separated | homogeneous |

As seen in Examples 55-60, the preferred sorbitan ester-ethoxylated sorbitan ester mixture is any combination of sorbitan monooleate and ethoxylated sorbitan monooleate that result in a net HLB between 12.2 and 14.2, most preferably 12.9.

The preferred compositions exhibit water clear stability when diluted in 300 ppm hard water as illustrated by Examples 55-60.

| | Ex. 55 | Ex. 56 | Ex. 57 |
|---|---|---|---|
| Lactic Acid | 16.9 | 16.9 | 16.9 |
| Sodium Lauryl Sulfate | 9.6 | 11.0 | 12.0 |
| Kosher Sorbitan Monooleate | 3.0 | 3.0 | 3.0 |
| Kosher Polyoxyethylene (20) | 12.0 | 12.0 | 12.0 |
| Sorbitan Monooleate | | | |
| Ethanol | 3.0 | 3.0 | 3.0 |
| Deionized water | q.s. to 100 | q.s. to 100 | q.s. to 100 |
| Net HLB of Sorbitan mixture | 12.9 | 12.9 | 12.9 |
| 1:170 dilution, 24 hours* | clear | clear | clear |
| 1:170 dilution, 48 hours* | clear | clear | clear |

*300 ppm hard water

| | Ex. 58 | Ex. 59 | Ex. 60 |
|---|---|---|---|
| Lactic Acid | 8.8 | 10.0 | 13.2 |
| Sodium Lauryl Sulfate | 9.6 | 9.6 | 9.6 |
| Kosher Sorbitan Monooleate | 3.0 | 3.0 | 3.0 |
| Kosher Polyoxyethylene (20) | 12.0 | 12.0 | 12.0 |
| Sorbitan Monooleate | | | |
| Ethanol | 3.0 | 3.0 | 3.0 |
| Deionized water | q.s. to 100 | q.s. to 100 | q.s. to 100 |
| Net HLB of Sorbitan mixture | 12.9 | 12.9 | 12.9 |
| 1:170 dilution, 24 hours* | clear | clear | clear |
| 1:170 dilution, 48 hours* | clear | clear | clear |

*300 ppm hard water

Alternatively, the sorbitan ester-ethoxylated sorbitan ester can be substituted with other toxicologically acceptable nonionic surfactant(s) (e.g., derived from edible oils) if the net HLB is in the range between 12.2 and 15.9, with the most preferable HLB being 12.9.

Optionally, lactic acid may be substituted in whole or in part with food grade acids such as benzoic and acetic.

Optionally, sodium lauryl sulfate may be substituted in whole or in part with other toxicologically acceptable anionic surfactants such as dodecyl benzene sulfonic acid.

For use, and as seen in Examples 53-60, the concentrate is diluted with potable water at the rate of 1:170 concentrate:water. To illustrate the enhanced stability of the invention, the concentrate is diluted with water containing 300 ppm hardness ions (Ca:Mg ratio 2:1) the water is prepared according to the method on ASTM D 3050-72T. This is shown in previous Example 24.

It is noted that the diluted solutions of compositions without the sorbitan ester-ethoxylated sorbitan ester combinations become cloudy as the anionic-hard water precipitate form. There is also a maximum quantity of the anionic surfactant that the sorbitan ester-ethoxylated sorbitan ester combination can effectively inhibit the formation of the hard water precipitation, as seen in Examples 60-62.

| | Ex. 60 | Ex. 61 | Ex. 62 |
|---|---|---|---|
| Lactic Acid | 16.9 | 16.9 | 16.9 |
| Sodium Lauryl Sulfate | 9.6 | 9.6 | 15.0 |
| Kosher Sorbitan Monooleate | - | - | 3.0 |
| Kosher Polyoxyethylene (20) | - | - | 12.0 |
| Sorbitan Monooleate | | | |
| Ethanol | - | 3.0 | 3.0 |
| Deionized water | q.s. to 100 | q.s. to 100 | q.s. to 100 |
| 1:170 dilution, 24 hours* | Precipitate | Precipitate | Precipitate |
| 1:170 dilution, 48 hours* | Precipitate | Precipitate | Precipitate |

*300 ppm hard water

Interestingly, it is also noted that lactic acid, sodium sulfate and deionized water mixtures are not stable, but form solid crystalline precipitates. The sorbitan ester/ethanol mixture stabilizes the compositions against the crystalline precipitation. Ethanol alone also has the effect of stabilizing the composition, but only in higher quantities. Higher quantities are not desirable as the compositions become flammable mixtures. Flammable mixtures pose additional burden as to storage and transportation requirements. This is demonstrated in Examples 63-65.

| | Ex. 63 | Ex. 64 | Ex. 65 |
|---|---|---|---|
| Lactic Acid | 16.9 | 16.9 | 16.9 |
| Sodium Lauryl Sulfate | 9.6 | 9.6 | 9.6 |
| Kosher Sorbitan Monooleate | - | - | 3.0 |
| Kosher Polyoxyethylene (20) | - | - | 12.0 |
| Sorbitan Monooleate | | | |
| Ethanol | 10.0 | 20.0 | 3.0 |
| Deionized water | q.s. to 100 | q.s. to 100 | q.s. to 100 |
| Composition stability | Precipitate | Stable | Stable |
| Flash Point (TCC) | >200° F. | >200° F. | >200° F. |
| 1:170 dilution, 24 hours* | Precipitate | Precipitate | Clear |
| 1:170 dilution, 48 hours* | Precipitate | Precipitate | Clear |

*300 ppm hard water
(TCC) is Tag Closed Cup method

The compositions have antimicrobial properties against gram negative and gram positive pathogenic bacteria. When evaluated by the AOAC food contact surface sanitizer test, the preferred composition, diluted with 300 ppm hard water, demonstrated efficacy against Salmonella choleraesuis and Staphylococcus aereus. This is seen in the following Example 66.

| | Ex. 66 |
|---|---|
| Lactic Acid | 16.9 |
| Sodium Lauryl Sulfate | 9.6 |
| Kosher Sorbitan Monooleate | 3.0 |
| Kosher Polyoxyethylene (20 Sorbitan | 12.0 |
| Monooleate | |
| Ethanol | 3.0 |
| Deionized water | q.s. to 100 |
| 1:170 dilution* Salmonella choleraesuis | >8 log reduction |
| 1:170 dilution* Staphylococcus aereus | >8 log reduction |

*300 ppm hard water

Examples 67 and 68 demonstrate the efficacy of the invention on produce. The produce samples were inoculated by dipping into dilute suspensions of either E.coli 0157:H7 or Listeria monocytogenes. The inoculated produce was air dried for 24 hours and then exposed to the preferred composition for 5 minutes. The produce was then placed in a sterile bag with 30 mls sterile 0.1% peptone water and massaged or stomached. 1 ml aliquots were serially diluted and surface plated to determine the numbers of E.coli or L.monocytogenes survivors. D-values (the time it takes to achieve a 1-log reduction) were then determined by linear regression. Values for a 25 ppm chlorine solution are provided for comparison purposes. 25 ppm chlorine solutions are commonly used for washing fruits and vegetables.

| | Ex. 67 | Ex. 68 |
|---|---|---|
| Lactic Acid | 16.9 | |
| Sodium Lauryl Sul- | 9.6 | |
| fate | | |
| Kosher Sorbitan | 3.0 | |
| Monooleate | | |
| Kosher Polyoxy- | 12.0 | |
| ethylene (20 | | |
| Sorbitan Mono- | | |
| oleate | | |
| Ethanol | 3.0 | |
| Deionized water | q.s. to 100 | |
| Chlorine | | 25 ppm |

| | |
|---|---|
| D-values (seconds) | D-values (seconds) |

| | E.coli | L.mono- | E.coli | L.mono- |
|---|---|---|---|---|
| Produce | O157:H7 | cytogenes | O157:H7 | cytogenes |
| Whole apples | 40 | 42 | 35 | 34 |
| Sliced apples | 72 | 78 | 60 | 64 |
| Whole lettuce | 41 | 39 | 37 | 41 |
| Shredded lettuce | 79 | 82 | 64 | 61 |
| Strawberries | 39 | 37 | 33 | 37 |

While ethanol is the preferred alcohol for stabilizing the composition of this invention, other alcohols could be employed such as food grade alcohols.

The compositions of this invention can be employed to wash the following fruits and vegetables:

Citrus Fruits

| | |
|---|---|
| Oranges | Tangelos |
| Grapefruit | Tangerines |
| Lemons | Temples |
| Limes | |

Non-Citrus Fruits

| | | |
|---|---|---|
| Apples | Figs | Peaches |
| Apricots | Grapes | Pears |
| Avocados | Guavas | Pineapples |
| Bananas | Honeydews | Plums |
| Cantaloupes | Kiwifruit | Prunes |
| Cherries | Nectarines | Strawberries |
| Cranberries | Olives | Watermelons |
| Dates | Papayas | |

Vegetables

| | | |
|---|---|---|
| Artichokes | Carrots | Lettuce |
| Asparagus | Cauliflower | Head |
| Beans, Lima | Celery | Leaf |
| Beans, Snap | Corn | Romaine |
| Beets | Cucumbers | Onions |
| Broccoli | Eggplant | Peas |
| Brussel Sprouts | Escarole Endive | Peppers |
| Cabbage | Garlic | Spinach |
| | | Tomatoes |

While certain examples have been set forth for the purpose of illustrating the compositions of this invention, other variations and modifications of this invention will be obvious to those skilled in this art. For example, flavors and/or fragrances can be added thereto. This invention is not to be limited except as set forth in the following claims.

1. A composition for cleaning edible fruits, vegetables, and hard food contact surfaces comprising:
about 10%/wt. to about 45%/wt. of an edible organic acid selected from the group consisting of lactic acid, benzoic acid and acetic acid;
about 5%/wt. to about 30%/wt. of an anionic surfactant;
about 6%/wt. to about 15%/wt. of a nonethoxylated sorbitan derivative and an ethoxylated sorbitan derivative;
and 10%/wt. to about 79%/wt. of water.

2. The composition of claim 1 wherein the sorbitan derivatives are derived from a C₁₂-C₁₈ aliphatic acid.

3. The composition of claim 2 wherein the aliphatic acid is oleic acid.

4. The composition of claim 2 wherein the aliphatic acid is palmitic acid.

5. The composition of claim 2 wherein the aliphatic acid is stearic acid.

6. The composition of claim 2 wherein the aliphatic acid is lauric acid.

7. The composition of claim 2 wherein the nonethoxylated sorbitan derivative and the ethoxylated sorbitan derivative are present in a ratio of about 1:4 to 1:12, respectively.

8. The composition of claim 1 wherein the anionic surfactant is sodium lauryl sulfate.

9. The composition of claim 1 wherein the sorbitan derivatives are sorbitan monooleates.

10. A composition for cleaning edible fruits, vegetables and hard, food contact surfaces comprising:
about 16%/wt. of an edible organic acid selected from the group, the group consisting of lactic acid, benzoic acid and acetic acid;
about 9.6%/wt. of an anionic surfactant;
about 1%/wt. of a nonethoxylated sorbitan derivative;
about 12%/wt. of an ethoxylated sorbitan derivative; and
about 61.4%/wt. water.

11. The composition of claim 10 wherein the edible organic acid is citric acid.

12. The composition of claim 10 wherein the anionic surfactant is sodium lauryl sulfate.

13. A composition for cleaning edible fruits, vegetables and hard, food contact surfaces comprising:
an edible organic acid;
an anionic surfactant;
a nonethoxylated sorbitan derivative;
an ethoxylated sorbitan derivative;
a food grade alcohol; and
water

14. The composition of claim 13 wherein the food grade alcohol is ethanol.

15. The composition of claim 14 wherein the edible organic acid is lactic acid.

16. The composition of 14 wherein the non-ethoxylated sorbitan derivative is sorbitan monooleate and the ethanoxylated sorbitan derivative is polyoxyethylene sorbitan.

17. A composition for cleaning edible fruits, vegetables and hard, food contact surfaces comprising:
an edible organic acid;
an anionic surfactant;
a nonionic surfactant having a hydrophilic-lipophilic balance in the range of between 12 to 14;
a food grade alcohol; and
water

18. The composition of claim 17 wherein the food grade alcohol is ethanol.

19. The composition of claim 18 wherein the organic acid is lactic acid.

20. The composition of claim 18 wherein the nonethoxylated sorbitan derivative is sorbitan monooleate and the ethoxylated sorbitan derivative is polyoxyethylene sorbitan.

21. A composition for cleaning edible fruits, vegetables, and hard food contact surfaces comprising:
about 5%/wt. to about 40%/wt. of an edible organic acid selected from the group consisting of lactic acid, benzoic acid and acetic acid;
about 5%/wt. to about 15%/wt. of an anionic surfactant;
about 6%/wt. to about 15%/wt. of a nonethoxylated sorbitan derivative and an ethoxylated sorbitan derivative;
about 1%/wt. to about 7%/wt. of a food grade alcohol; and
about 23%/wt. to about 83%/wt. of water.

22. A composition for cleaning edible fruits, vegetables, and hard food contact surfaces comprising:
about 16%/wt. of an edible organic acid selected from the group consisting of lactic acid, benzoic acid and acetic acid;
about 9.6%/wt. of an anionic surfactant;
about 3%/wt. of a nonethoxylated sorbitan derivative and an ethoxylated sorbitan derivative;
about 3%/wt. of ethanol; and
about 56.4%/wt. of water.

23. A method of cleaning edible fruits, vegetables and hard, food contact surfaces comprising contacting the fruits, vegetables and surfaces with the composition of claim 13.

24. A method of cleaning edible fruits, vegetables and hard, food contact surfaces comprising contacting the fruits, vegetables and surfaces with the composition of claim 17.
